(19) United States
(12) Patent Application Publication
(10) Pub. No.: US 2012/0169698 A1
(43) Pub. Date: Jul. 5, 2012

(54) DISPLAY APPARATUS AND METHOD OF DRIVING THE SAME

(75) Inventors: Jae Wan PARK, Seoul (KR); Junghwan CHO, Asan-si (KR); MyeongSu KIM, Cheonan-si (KR); Ga-Na KIM, Asan-si (KR)

(73) Assignee: SAMSUNG ELECTRONICS CO., LTD., Suwon-si (KR)

(21) Appl. No.: 13/326,955

(22) Filed: Dec. 15, 2011

(30) Foreign Application Priority Data
Dec. 30, 2010 (KR) 10-2010-0139482

(51) Int. Cl. G09G 5/00

(52) U.S. Cl. 345/211

(57) ABSTRACT

A display apparatus includes a display panel which displays an image at a first driving frequency in a normal mode or at a second driving frequency less than the first driving frequency in a low-voltage mode; a data driver which provides a data voltage to the display panel; a gate driver which sequentially applies gate signals to the display panel in response to a first gate control signal or a second gate control signal; and a timing controller which provides the first gate control signal to the gate driver in the normal mode, and provides the second gate control signal to the gate driver in the low-voltage mode, where the second gate control signal has a frequency less than the first gate control signal and has a high period having a length substantially equal to a length of a high period of the first gate control signal.

This application claims priority to Korean Patent Application No. 10-2010-0139482, filed on Dec. 30, 2010, and all the benefits accruing therefrom under 35 U.S.C. §119, the content of which in its entirety is herein incorporated by reference.

### BACKGROUND OF THE INVENTION

(1) Field of the Invention

The general inventive concepts relate to a display apparatus and a method of driving the display apparatus. More particularly, the general inventive concepts relate to a display apparatus with improved display quality and reduced power consumption, and a method of driving the display apparatus.

(2) Description of the Related Art

A liquid crystal display displays an image in response to a data signal from an external device. In general, the liquid crystal display includes a display panel to display the image and a driver to drive the display panel.

The liquid crystal display has been developed for slimness and low power consumption since the liquid crystal display is widely used in mobile electric devices, such as smart phones and tablet personal computers (“PC”s), for example. As a result, various methods for reducing the power consumption of the liquid crystal display have been researched. However, those methods may have problems such as deterioration in contrast ratio and defect in visibility.

### BRIEF SUMMARY OF THE INVENTION

Exemplary embodiments of the present invention provide a display apparatus with improved display quality and reduced power consumption.

Exemplary embodiments of the present invention provide a method of driving the display apparatus.

According to an exemplary embodiment, a display apparatus includes a display panel, a data driver, a gate driver and a timing controller.

The display panel displays an image in at least one of a normal mode and a low-voltage mode, where the image is displayed at a first driving frequency in the normal mode and the image is displayed at a second driving frequency lessr than the first driving frequency in a low-voltage mode. The data driver converts an image data signal and provides a data voltage to the display panel, and the gate driver sequentially applies a plurality of gate signals to the display panel in response to at least one of a first gate control signal and a second gate control signal.

The timing controller provides the image data signal to the data driver, provides the first gate control signal to the gate driver in the normal mode, and provides the second gate control signal to the gate driver in the low-voltage mode.

The second gate control signal has a frequency less than the first gate control signal and has a high period having a length substantially equal to a length of a high period of the first gate control signal. The first and second gate control signals may be a gate clock signal.

In an exemplary embodiment, the timing controller may include a data converter which outputs the image data signal to the data driver, and a control signal generator which generates the first gate control signal as a gate control signal when a control mode is the normal mode and generates the second gate control signal as the gate control signal when the control mode is the low-voltage mode.

In an exemplary embodiment, the timing controller may include a control mode determiner which receives a reference signal including a plurality of effective periods and a plurality of blank periods and changes the control mode to be different from a previous control mode according to a length of each of the bland period.

In an exemplary embodiment, the control mode determiner may include a counter that counts the length of each of the blank periods of the reference signal to output a counted value, a comparator that compares the counted value with a predetermined reference value to generate a flag signal based on the compared result, and a mode setter that changes the control mode in response to the flag signal.

According to an exemplary embodiment, a method of driving a display apparatus receiving a reference signal including a plurality of effective periods and a plurality of blank periods from an exterior; determining a control mode based on the reference signal, wherein the control mode is at least one of a normal mode using a first driving frequency and a low-voltage mode using a second driving frequency; generating a first gate control signal when the control mode is the normal mode and generating a second gate control signal when the control mode is the low-voltage mode, wherein the second gate control signal has a frequency less than a frequency of the first gate control signal and has a high period having a length substantially equal to a length of a high period of the first gate control signal; and generating a plurality of gate signals based on at least one of the first gate control signal and the second gate control signal, and sequentially outputs the plurality of gate signals.

According to the above, deterioration in the contrast ratio due to changed charge time when the display panel is driven in the low-voltage mode is effectively prevented and defects in visibility, such as screen flickering and screenflashing, for example, are effectively prevented, and the display quality is thereby substantially improved. In addition, the driving frequency becomes less than a normal frequency during the low-voltage mode, and thus the number of the clock signals is substantially reduced, and the power consumption is thereby substantially reduced.

### BRIEF DESCRIPTION OF THE DRAWINGS

The above and other features, aspects and advantages of the present invention will become readily apparent by reference to the following detailed description when considered in conjunction with the accompanying drawings wherein:

FIG. 1 is a block diagram showing an exemplary embodiment of a display apparatus according to the present invention;

FIG. 2 is a block diagram showing an exemplary embodiment of a timing controller shown in FIG. 1;

FIG. 3 is a block diagram showing an exemplary embodiment of a control signal generator shown in FIG. 2;

FIG. 4 is a signal timing diagram of signals shown in FIG. 3; and

FIG. 5 is a signal timing diagram of a control signal, a gate clock control signal and a plurality of gate signals.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the present invention will be explained in detail with reference to the accompanying drawings.

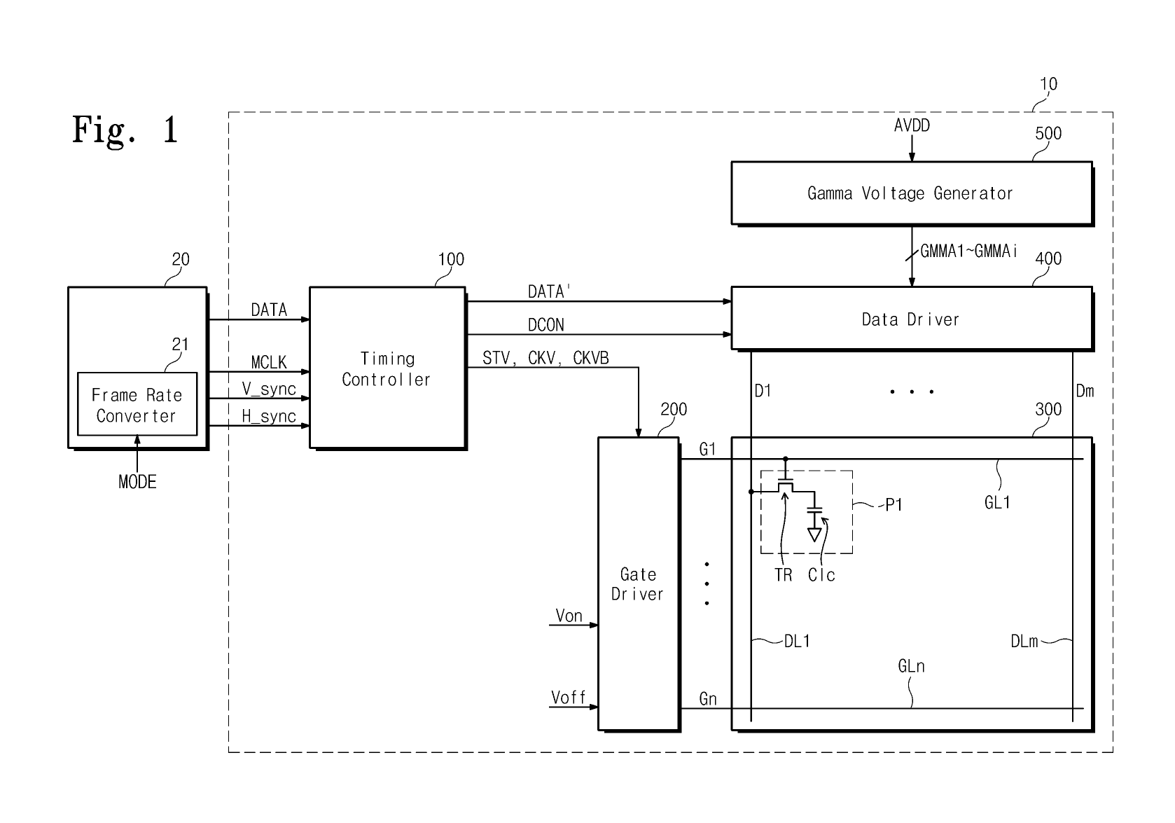

FIG. 1 is a block diagram showing an exemplary embodiment of a display apparatus according to the present invention.

Referring to FIG. 1, a display apparatus 10 includes a timing controller 100, a gate driver 200, a display panel 300, a data driver 400 and a gamma voltage generator 500. The display apparatus 10 displays an image in response to various signals provided from an external system 20.

The external system 20 includes a frame rate converter 21. The frame rate converter 21 converts a frequency of a main clock signal MCLK in response to a mode control signal MODE. The mode control signal MODE is determined based on the type of an image to be displayed. In an exemplary embodiment, the mode control signal MODE corresponds to a normal mode using a first driving frequency and a low-voltage mode using a second driving frequency less than the first driving frequency.

The main clock signal MCLK may have the first driving frequency or the second driving frequency. When the frequency of the main clock signal MCLK is changed, the frame rate converter 21 transmits a vertical synchronization signal V_sync that have a blank period longer than a frequency of the main clock signal MCLK when the driving frequency is not changed.

The timing controller 100 receives a plurality of image signals DATA, a horizontal synchronization signal H_sync to synchronize the external system 20 to the scan timing of horizontal scan direction signals of the display panel 300, the vertical synchronization signal V_sync to synchronize the external system 20 to the scan timing of vertical scan direction signals of the display panel 300, and the main clock signal MCLK. In an exemplary embodiment, the external system 20 may be a television system or a graphic board, for example.

The timing controller 100 converts a data format of the image signals DATA based on an interface between the data driver 400 and the timing controller 100 and provides the converted image signals DATA' to the data driver. The timing controller 100 further provides a data control signal DCON, e.g., an output start signal, a horizontal start signal and a polarity inversion signal, to the data driver 400, and provides a gate control signal, e.g., a vertical start signal STV, a clock signal CKV and a clock bar signal CKVB, to the gate driver 200.

The display panel 300 displays the image. The display panel 300 is operated in the normal mode or in the low-voltage mode. The display panel 300 in the normal mode displays the image at the first driving frequency, and the display panel 300 in the low-voltage mode displays the image at the second driving frequency less than the first driving frequency. The mode of the display panel 300 is determined by the frame rate converter 21 included in the external system 20. In an exemplary embodiment, the frame rate converter 21 may be integrally formed in the external system 20. In one exemplary embodiment, for example, the first driving frequency may be about 60 hertz (Hz) and the second driving frequency may be about 40 Hz.

The display panel 300 includes a plurality of pixels P1, and also includes a plurality of gate lines GL1 to GLn and a plurality of data lines DL1 to DLm to apply signals to the pixels P1. The gate lines GL1 to GLn receive gate signals G1 to Gn, and the data lines DL1 to DLm receive data voltages D1 to Dm. Accordingly, when each pixel row of the pixels arranged in a matrix configuration is turned on in response to a corresponding gate line of the gate lines G1 to Gn, the data signals D1 to Dm are applied to the pixels connected to the turned-on pixel row, thereby scanning the pixels P1 in each row. When all of the pixels P1 are scanned, an image corresponding to a unit frame is displayed on the display panel 300.

In one exemplary embodiment, for example, each pixel P1 includes a thin film transistor TR connected to a corresponding gate line and a corresponding data line, and a liquid crystal capacitor Clc connected to a drain electrode of the thin film transistor TR, but the structure of each pixel P1 is not limited thereto.

The gate driver 200 receives a gate-on voltage Von and a gate-off voltage Voff and sequentially outputs the gate signals G1 to Gn in response to control signals STV, CKV and CKVB provided from the timing controller 100.

The gamma voltage generator 500 receives an analog driving voltage AVDD and generates a plurality of gamma reference voltages GMMA1 to GMMAi. The gamma reference voltages GMMA1 to GMMAi are applied to the data driver 400. The gamma voltage generator 500 has a resistor-string structure, in which individual resistors of a plurality of resistors are connected in series and outputs electric potentials at nodes as the gamma reference voltages GMMA1 to GMMAi. Each node is connected to two adjacent resistors thereof.

In response to the data control signal DCON from the data driver 400, the data driver 400 selects voltages corresponding to the image signals DATA' among a plurality of gamma reference voltages GMMA1 to GMMAi and outputs the voltages as the data voltages D1 to Dm. The data voltages D1 to Dm output from the gamma voltage generator 500 are applied to the display panel 300.

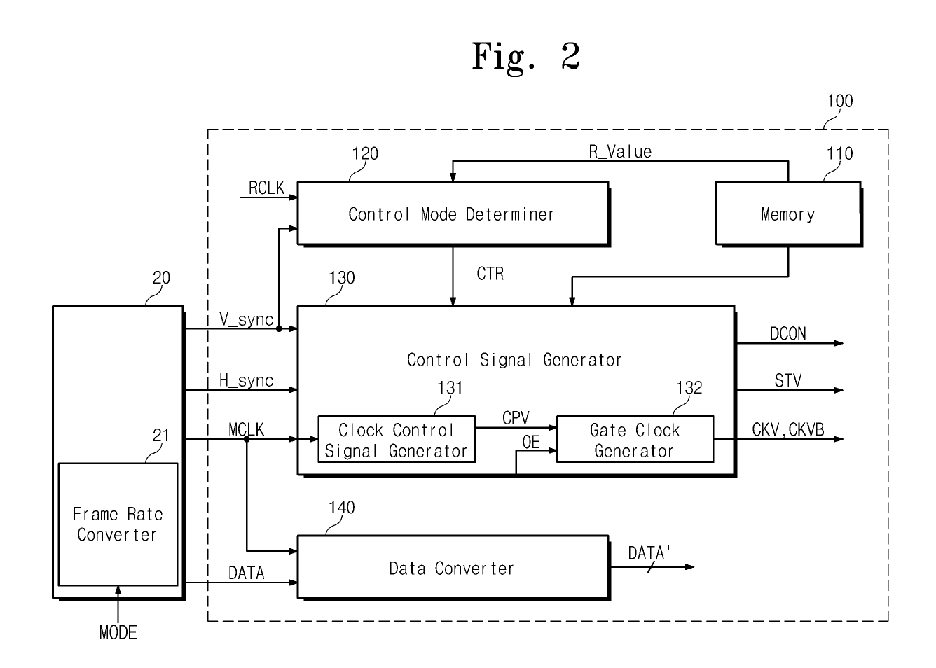

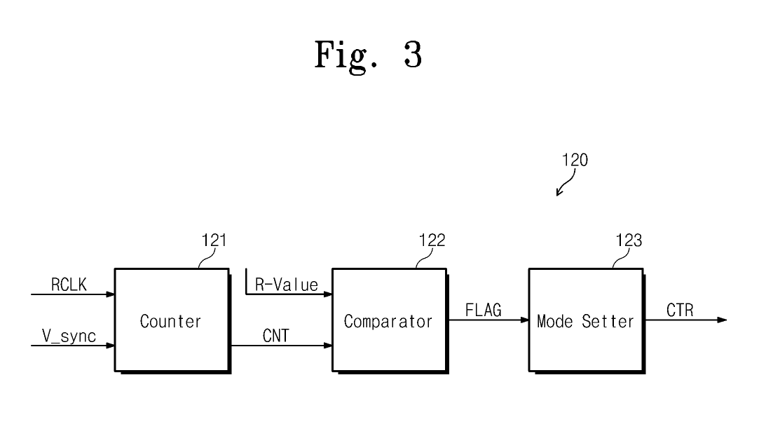

Hereinafter, a circuit configuration of the timing controller 100 will be described in detail with reference to FIGS. 2 and 3.

FIG. 2 is a block diagram showing an exemplary embodiment of the timing controller shown in FIG. 1, and FIG. 3 is a block diagram showing an exemplary embodiment of a control signal generator shown in FIG. 2.

Referring to FIG. 2, the timing controller 100 includes a memory 110, a control mode determiner 120, a control signal generator 130 and a data converter 140.

The data converter 140 converts the data format of the image signals DATA to generate converted image signals DATA', and transmits the converted image signals DATA′ to the data driver 400 in response to the main clock signal MCLK.

The control mode determiner 120 receives the vertical synchronization signal V_sync, counts the length of the blank period of the vertical synchronization signal V_sync using a reference clock RCLK, and compares the counted value with a reference value R_value provided from the memory 110 to generate a control mode signal CTR.

The control signal generator 130 generates the gate control signals in response to the control mode signal CTR. The control signal generator 130 receives the vertical synchronization signal V_sync, the horizontal synchronization signal H_sync and the main clock signal MCLK, and the control signal generator 130 generates the data control signal DCON, the vertical start signal STV, the gate clock signal CKV and the gate clock bar signal CKVB.

The control signal generator 130 includes a clock control signal generator 131 and a gate clock generator 132. The clock control signal generator 131 generates a gate clock control signal CPV in response to the main clock signal MCLK from the external device 20.

The gate clock generator 132 receives the gate clock control signal CPV and an output control signal OE and generates the gate clock signal CKV. The gate clock generator 132 generates the gate clock bar signal CKVB in response to the gate clock control signal CPV and the output control signal OE. The gate clock signal CKV and the gate clock bar signal CKVB are applied to the gate driver 200. The gate clock signal CKV has a waveform substantially identical to a waveform of the gate clock control signal CPV. The memory 110 stores the reference value R_value and provides the reference value R_value to the control mode determiner 120 to generate the control mode signal CTR.

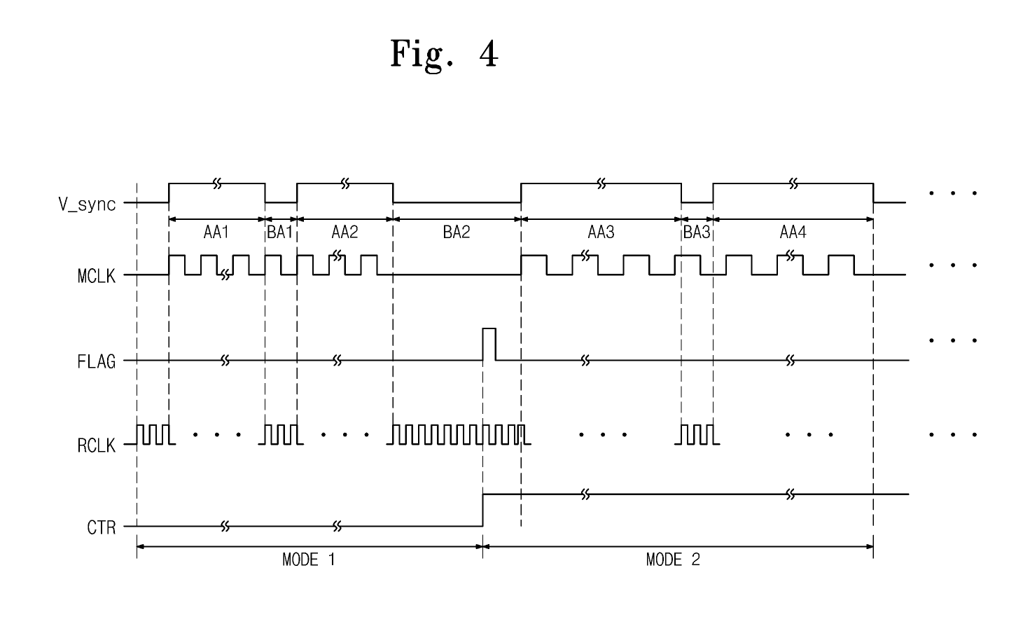

FIG. 4 is a signal timing diagram of signals shown in FIG. 3.

Referring to FIGS. 3 and 4, the control mode determiner 120 includes a counter 121, a comparator 122 and a mode setter 123.

The counter 121 receives the reference clock RCLK and the vertical synchronization signal V_sync. The synchronization signal V_sync includes a plurality of effective periods, e.g., a first effective period AA1, a second effective period AA2, a third effective period AA3 and a fourth effective period AA4, and a plurality of blank periods, e.g., a blank period BA1, a blank period BA2 and a blank period BA3. For convenience of explanation, only four effective periods AA1, AA2, AA3 and AA4 and three blank periods BA1, BA2 and BA3 have been shown in FIG. 4, but the number of the effective periods and the blank periods should not be limited thereto.

As shown in FIG. 4, each of the blank periods BA1, BA2 and BA3 is positioned between two adjacent effective periods. More specifically, the blank period BA1 is positioned between the first effective period AA1 and the second effective period AA2, the blank period BA2 is positioned between the second effective period AA2 and the third effective period AA3, and the blank period BA3 is positioned between the third effective period AA3 and the fourth effective period AA4. In the case that the frequency of the main clock signal MCLK is changed, the length of the blank period of the vertical synchronization signal V_sync corresponding to a period in which the frequency of the main clock signal MCLK is changed is longer than a length of the blank period of a regular vertical synchronization signal V_sync, e.g., the vertical synchronization signal V_sync before and after the frequency change of the main clock signal MCLK. Hereinafter, the blank period of the regular vertical synchronization signal, e.g., the blank period BA1 and the blank period BA3, is referred to as a first blank period, and the blank period of the vertical synchronization signal V_sync corresponding to the period in which the frequency of the main clock signal MCLK is changed, e.g., the blank period BA2, is referred to as a second blank period. In an exemplary embodiment, the second blank period may have a length greater than twice the length of the first blank period.

The counter 121 counts a number of the cycles of the reference clocks RCLK during each of the blank periods BA1, BA2, and BA3 to measure the length of each of the blank periods BA1, BA2, and BA3.

The comparator 122 compares a measured value CNT corresponding to the length of a blank period with the reference value R_value to generate a flag signal FLAG. The mode setter 123 changes the control mode signal CTR in response to the flag signal FLAG.

Referring to FIG. 4, since the measured value CNT of the blank period BA1 positioned between the first and second effective periods AA1 and AA2 and the measured value CNT of the blank period BA3 positioned between the third and fourth effective periods AA3 and AA4 is less than the reference value R_value, the blank periods BA1 and BA3 correspond to the first blank period and the flag signal FLAG is maintained in a low state. When flag signal FLAG is maintained in the low state, a control mode based on the mode control signal CTR is maintained in its previous state.

However, when the blank period BA2 positioned between the second effective period AA2 and the third effective period AA3 is greater than or equal to the reference value R_value, the blank period BA2 corresponds to the second blank period and the flag signal FLAG is converted to a high state. The control mode is converted to a low-voltage mode MODE2 from a normal mode MODE1 by the control mode signal CTR, and the flag signal FLAG is initialized to the low state.

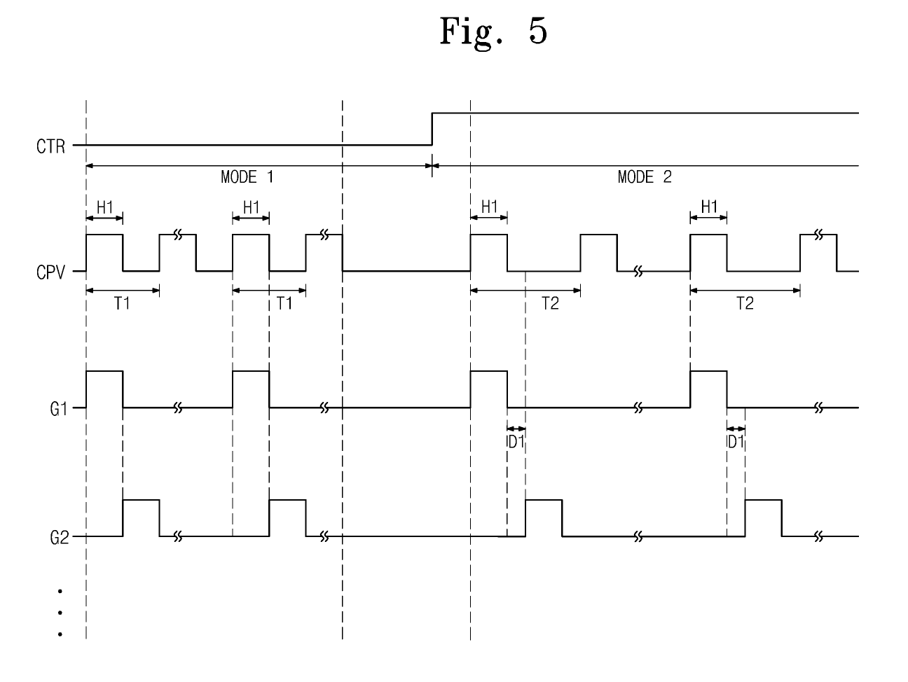

Hereinafter, the gate clock control signal CPV and first and second gate signals based on the control mode signal CTR will be described in detail with reference to FIG. 5.

FIG. 5 is a signal timing diagram of a control signal, a gate clock control signal and a plurality of gate signals. In FIG. 5, as described above, since the gate clock signal CKV has a waveform substantially identical to a waveform of the gate clock control signal CPV, detailed description of the gate clock signal CKV will be omitted. In addition, for the convenience of description, only the waveforms of the first and second gate signals G1 and G2 among the gate signals G1 to Gn in FIG. 1 will be described.

Referring to FIGS. 1 and 5, during the normal mode MODE1, the gate clock control signal CPV includes a plurality of pulses (hereinafter, referred to as a first gate clock control signal), each of which has a first period T1 and a first high period H1. In one exemplary embodiment, for example, the first high period H1 has a length corresponding to about a half a length of the first period T1.

The first signal G1 and the second gate signal G2 are generated based on the gate clock signal CKV. As described above, the gate clock signal CKV has the waveform substantially identical to the gate clock control signal CPV, the gate signals will be described with reference to the gate clock control signal CPV instead of the gate clock signal CKV.

In an exemplary embodiment, odd-numbered gate signals are sequentially generated to have a high period corresponding to the first high period of the gate clock control signal CPV, and even-numbered gate signals are sequentially generated to have a high period corresponding to a low period of the gate clock control signal CPV. Accordingly, as shown in FIG. 5, the first gate signal G1 is output corresponding to the first high period of the first period T1 of the gate clock control signal CPV, and the second gate signal G2 is output corresponding to the low period of the first period T1 of the gate clock control signal CPV to have the high period.

During the low-voltage mode MODE2, the gate clock control signal CPV includes a plurality of pulses (hereinafter, referred to as a second gate clock control signal), each of which has a second period T2 and the first high period H1. The second frequency is less than the first frequency, and thus a length of the second period T2 is longer than a length of the first period T1. However, the second gate clock control signal has the first high period H1 substantially equal to the high period of the first gate clock control signal.

Since the gate clock control signal CPV has the same length of the first high period H1 both in the normal mode MODE1 and the low-voltage mode MODE2, the second gate clock control signal has a low period longer than the low period of the first gate clock control signal. In one exemplary embodiment, for example, when assuming that the first frequency is about 60 Hz and the second frequency is about 40 Hz, the length of the low period of the second gate clock control signal may be twice the length of the low period of the first gate clock control signal.

The odd-numbered gate signals are sequentially generated in synchronization with the high period of the second gate control signal CPV. However, the low period of the second gate clock control signal is longer than the low period of the first gate clock control signal, and the high period of the even-numbered gate signals has the length substantially equal to the length of the high period of the odd-numbered gate signals. Thus, each of the even-numbered gate signals is generated in a corresponding low period of the gate clock control signal CPV, but each of the even-numbered gate signals is output after a lapse of a predetermined time period D1 from a time point at which each of the odd-numbered gate signals is output during the low-voltage mode MODE2. In one exemplary embodiment, for example, when the low period of the second gate clock control signal CPV has the length twice the length of the high period, the second gate signal G2 is output after the lapse of the time period D1 corresponding to half of the first high period H1 from the time point at which the first gate signal G1 is output.

As described above, the timing controller 100 maintains the high periods of the gate clock control signal CPV to be substantially identical to each other when the control mode is changed, and thus each of the gate signals may have substantially a same length. Accordingly, a time period taken for the image signal to be applied to the pixel row connected to each gate line in the low-voltage mode is maintained substantially equal to a time period taken in the normal mode. Thus, deterioration in the contrast ratio due to changed charge time duration when the display panel is driven in the low-voltage mode are effectively prevented, and defects in visibility, such as screen flickering and screen flashing, for example, are also effectively prevented, and the display quality is thereby substantially improved. In addition, the driving frequency becomes lower than a normal frequency during the low-voltage mode, and thus the number of the clock signals may be substantially reduced, and the power consumption is thereby substantially reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel which displays an image in at least one of a normal mode and a low-voltage mode, wherein the image is displayed at a first driving frequency in the normal mode and the image is displayed at a second driving frequency less than the first driving frequency in the low-voltage mode;
a data driver which converts an image data signal and provides a data voltage to the display panel;
a gate driver which sequentially applies a plurality of gate signals to the display panel in response to at least one of a first gate control signal and a second gate control signal; and
a timing controller which provides the image data signal to the data driver, provides the first gate control signal to the gate driver in the normal mode, and provides the second gate control signal to the gate driver in the low-voltage mode,
wherein the second gate control signal has a frequency less than the first gate control signal and has a high period having a length substantially equal to a length of a high period of the first gate control signal.

2. The display apparatus of claim 1, wherein the timing controller comprises:
a data converter which outputs the image data signal to the data driver; and
a control signal generator which generates the first gate control signal as a gate control signal when a control mode is the normal mode and generates the second gate control signal as the gate control signal when the control mode is the low-voltage mode.

3. The display apparatus of claim 2, wherein the timing controller comprises a control mode determiner which receives a reference signal including a plurality of effective periods and a plurality of blank periods, and changes a control mode to be different from a previous control mode based on a length of each of the plurality of blank periods.

4. The display apparatus of claim 3, wherein the control mode determiner comprises:
a counter which counts the length of each of the plurality of blank periods of the reference signal to output a counted value;
a comparator which compares the counted value with a predetermined reference value and generates a flag signal based on the comparison of the counted value and the predetermined reference value; and
a mode setter which sets the control mode in response to the flag signal.

5. The display apparatus of claim 4, wherein the counter receives a reference clock and counts a number of the cycles in the reference clocks generated during each of the plurality of blank periods.

6. The display apparatus of claim 4, wherein the flag signal rises from a low level to a high level when the counted value is greater than or equal to the predetermined reference value, and the flag signal is in the low level after the control mode is changed.

7. The display apparatus of claim 4, wherein the mode setter maintains the control mode to be substantially the same as the previous control mode when the flag signal is maintained in the low level.

8. The display apparatus of claim 4, wherein the timing controller further comprises a memory which stores the predetermined reference value.

9. The display apparatus of claim 4, wherein the reference signal is a vertical synchronization signal to synchronize an external system to scan timing of a vertical scan direction signal of the display panel.

10. The display apparatus of claim 4, wherein the gate control signal comprises a gate clock signal.

11. The display apparatus of claim 10, wherein the control signal generator comprises:
a clock control signal generator which generates a gate clock control signal based on a clock signal provided from an exterior; and
a gate clock generator which generates the gate clock signal based on the gate control signal.

12. The display apparatus of claim 1, wherein when the gate driver receives the second gate control signal, the gate driver outputs a present gate signal of the plurality of the gate signals after a lapse of a predetermined time period from a time point at which a previous gate signal which is provided prior to the present gate signal is output.

13. A method of driving a display apparatus, the method comprising:
receiving a reference signal including a plurality of effective periods and a plurality of blank periods from an exterior;
determining a control mode based on the reference signal, wherein the control mode is at least one of a normal mode using a first driving frequency and a low-voltage mode using a second driving frequency;
generating a first gate control signal when the control mode is the normal mode and generating a second gate control signal when the control mode is the low-voltage mode, wherein the second gate control signal has a frequency less than a frequency of the first gate control signal and has a high period having a length substantially equal to a length of a high period of the first gate control signal; and
generating a plurality of gate signals based on at least one of the first gate control signal and the second gate control signal, and sequentially outputs the plurality of gate signals.

14. The method of claim 13, wherein the determining a control mode comprises:
counting a length of each of the blank periods of the reference signal to generate a counted value;
comparing the counted value with a predetermined reference value to generate a flag signal based on the comparison of the counted value and the predetermined reference value; and
changing the control mode in response to the flag signal.

15. The method of claim 14, wherein the flag signal rises from a low level to a high level when the counted value is greater than or equal to the predetermined reference value, and the flag signal is in the low level after the control mode is changed.

16. The method of claim 14, wherein the control mode is maintained to be the same as a previous control mode when the flag signal is maintained in a low level.

17. The method of claim 13, wherein the reference signal is a vertical synchronization signal to synchronize an external system to scan timing of a vertical scan direction signal of a display panel.

18. The method of claim 13, wherein a present gate signal of the plurality of gate signals is output after a lapse of a predetermined time period from a time point at which a previous gate signal which is provided prior to the present gate signal is output.

19. The method of claim 13, wherein at least one of the first gate control signal and the second gate control signal comprises a gate clock signal.
